(19) United States
(12) Patent Application Publication
(10) Pub. No.: US 2010/0224450 A1
(43) Pub. Date: Sep. 9, 2010

(54) REVERSIBLE OIL PAN WITH INTEGRATED OIL SUCTION TUBE

(75) Inventors: JAMES DODS, BARNARD CASTLE (GB); WAYNE SPOONER, DARLINGTON (GB); MATTHEW CLARK, DARLINGTON (GB); PAUL RICHARD TONKIN, NORTH YORKSHIRE (GB)

Correspondence Address: Studebaker & Brackett PC, One Fountain Square, 11911 Freedom Drive, Suite 750, Reston, VA, 20190, US

(73) Assignee: CUMMINS INC., INDIANAPOLIS, IN (US)

(21) Appl. No.: 12/398,097

(22) Filed: Mar. 4, 2009

(51) Int. Cl. F16N 31/00

(52) U.S. Cl. 184/106

(57) ABSTRACT

A reversible oil pan assembly including an oil suction tube. In one aspect, an oil pan assembly includes an oil pan and a suction tube connected to the oil pan. The suction tube includes an inlet to draw oil from the oil pan, and a plurality of outlets, each outlet configured to output oil that has been moved through the suction tube from the inlet.

### FIELD OF THE INVENTION

The present invention relates to oil pans for collecting oil in vehicles and other machines, and more particularly to oil pans using an oil suction tube.

### BACKGROUND OF THE INVENTION

Motor vehicles and other machines use oil for lubricating moving parts of the machine. In many vehicle implementations, oil is provided and collected in an oil pan as a reservoir. An oil pump draws oil from the bottom of the oil pan through a tube to recirculate the oil through the vehicle. For example, the oil is pressurized by an oil pump and is pumped through an oil filter to remove grit. From the oil pump the oil is provided to other components of the engine or vehicle, such as bearings, turbocharger, and pistons. For example, the oil can be provided into a crankshaft and connecting rod bearings and onto cylinder walls in an internal combustion engine, and eventually drips off the walls into the bottom of the crankcase due to gravity. In a wet sump system, oil collects in the oil pan at the bottom of the crankcase, from which it is circulated again into the vehicle and engine.

In current diesel engine vehicles or other vehicle configurations, a front sump oil pan or a rear sump oil pan are often used. A front sump oil pan can fit in a particular vehicle configuration and is configured to provide oil through a suction tube that is configured to join the oil pump inlet; oil is then circulated from the pump. In contrast, a rear sump oil pan fits into a different vehicle configuration and requires a different suction tube configured to deliver oil to the same oil pump but from a rear sump. Some production processes can use an oil pan that is fitted with one type of suction tube for front sump configurations, or a different type of suction tube for rear sump configurations.

One problem with current oil pans and their production methods is the use of multiple different types of suction tubes and/or oil pans for different vehicle configurations. Different types of tubes and pans requires an increased amount of part numbers in an inventory system. In addition, the use of different oil pan configurations allows for increased chances of assembly errors and undesired scrap on the production line when the wrong type of pan or tube is mistakenly used or assembled incorrectly.

Accordingly, a system and method for providing a single type of oil pan and suction tube that can be used in multiple configurations of a vehicle or other machine would be desirable in many applications.

### SUMMARY OF THE INVENTION

The invention of the present application relates to oil pans for collecting oil in vehicles and other machines. In one aspect of the invention, an oil pan assembly includes an oil pan and a suction tube connected to the oil pan. The suction tube includes an inlet to draw oil from the oil pan, and a plurality of outlets, each outlet configured to output oil that has been moved through the suction tube from the inlet.

In another aspect, an oil pan system for a vehicle includes an oil pan assembly comprising an oil pan and a suction tube connected to the oil pan. The suction tube includes an inlet to draw oil from the oil pan, and a plurality of outlets, each outlet configured to output oil that has been moved through the suction tube from the inlet. The system includes a surface for use in a vehicle, the surface configured such that the oil pan assembly is attached to the surface. Only one of the outlets of the suction tube is unblocked after attachment of the oil plan assembly. A similar aspect is provided for a method for implementing similar features.

The present invention provides an apparatus and method for an oil pan assembly that accommodates multiple oil pan configurations, allowing reduction of inventory complexity and greater flexibility in oil pan installation.

### BRIEF DESCRIPTION OF THE DRAWINGS

FIG. 1 is a perspective view of an oil pan assembly of the present invention;

FIG. 2 is a perspective view of the suction tube of the present invention;

FIG. 3 is a perspective exploded view of the oil pan assembly of FIG. 1; and

FIG. 4 is a perspective view of an example embodiment in which the oil pan assembly of FIG. 1 is connected to a portion of an internal combustion engine.

### DETAILED DESCRIPTION

The present invention relates to oil pans for collecting oil in vehicles and other machines, and more particularly to oil pans using an oil suction tube. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principle and features described herein.

The present invention is mainly described in terms of particular components provided in particular implementations. However, one of ordinary skill in the art will readily recognize that this apparatus will operate effectively in other implementations and applications. For example, the apparatus or systems usable with the present invention can take a number of different forms.

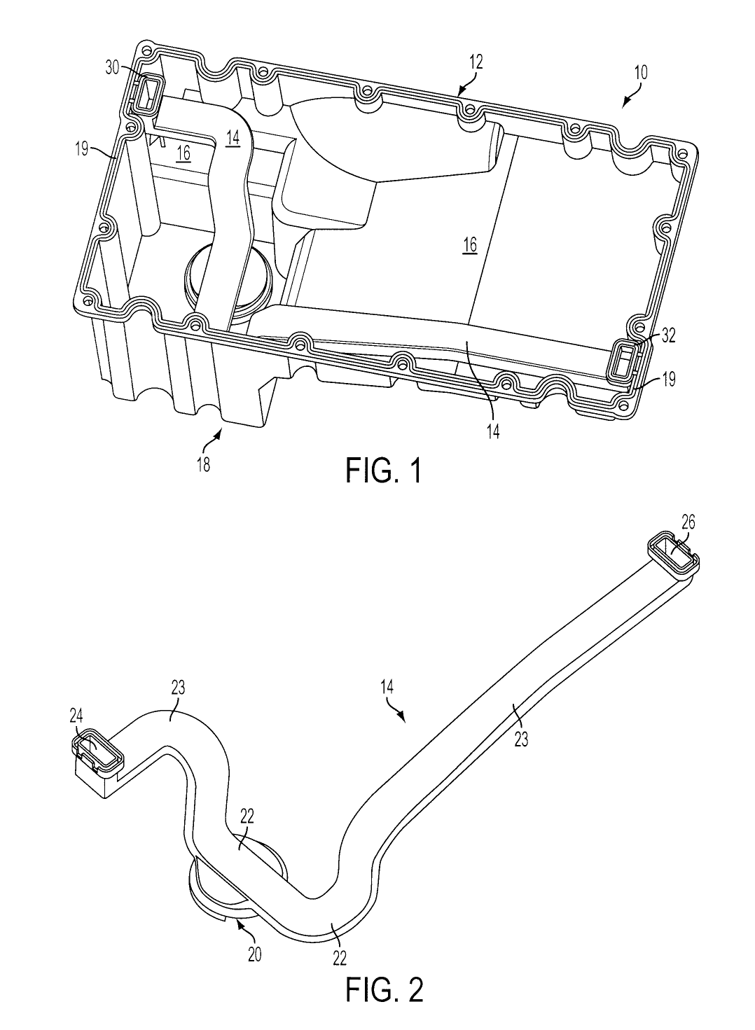

To more particularly describe the features of the present invention, please refer to FIGS. 1-4 in conjunction with the discussion below.

FIG. 1 is a perspective view of an oil pan assembly 10 of the present invention. Oil pan assembly 10 can be provided in a variety of different types of machines that require the collection and recirculation of oil. For example, oil pan assembly 10 can be used in vehicles such as automobiles which use an oil pan for oil collection. Diesel engine vehicles, for example, provide an oil pan for engine oil collection and recirculation.

Oil pan assembly 10 includes an oil pan 12 and a suction tube 14. Pan 12 is shown as a generally rectilinear shape, although it can take other shapes in other embodiments (oval, circular, etc.). Pan 12 can be made of any suitable material. In one embodiment, the pan 12 is injection-molded plastic, which is typically significantly cheaper than a stamped steel pan for large production volumes and also has superior noise emission suppression benefits.

A funneling portion 16 of the pan 12 receives oil that has fallen from an engine located above the pan 12, such as an internal combustion engine. In other embodiments, other types of machines may provide different components from which oil is collected in the pan. The funneling portion 16 includes a sloping surface that directs received oil toward a reservoir or sump 18 of the pan 12, which in the described embodiment is a deeper section of the pan than the shallower funneling portion 16. In some embodiments, the funneling portion 16 is made shallower due to vehicle configuration restrictions. For example, the oil pan assembly 10 may need to be fitted in an area where the funneling portion 16 is positioned near a vehicle axle and so needs to have less depth to provide clearance for that axle. With its greater volume, the reservoir 18 thus collects much of the oil received by the pan 12. In the example shown, the reservoir 18 is located near a corner of the pan 12, but can be located in other areas of the pan in other embodiments. Other embodiments can also provide different depths for the portions of the oil pan, including a same depth for the entire pan.

Pan 12 also includes a rim 19 at the top of the pan. Rim 19 includes an opening 30 and an opening 32. In the described embodiment, the openings 30 and 32 are provided at opposite sides of the pan 12 and face upwards in orientation as shown in FIG. 1, i.e., the openings 30 and 32 are oriented to be parallel to the top of the rim 19 of the oil pan 12.

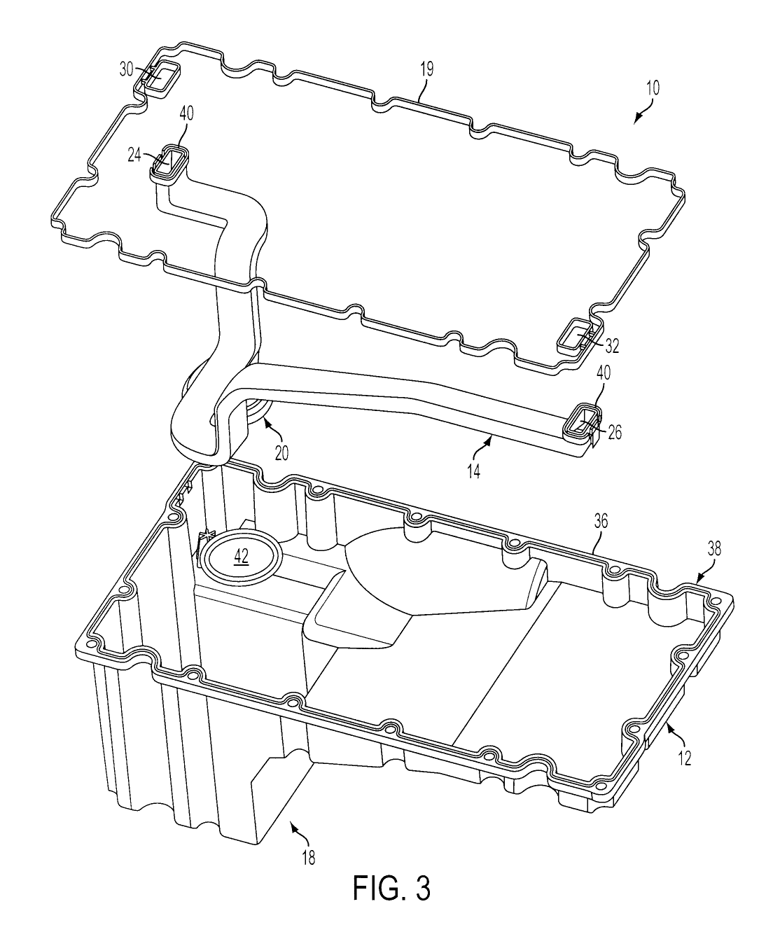

The oil in reservoir 18 is drawn into the suction tube 14 that is attached to the pan 12. This is accomplished in the described embodiment by an oil inlet 20 of the suction tube 14. FIG. 2 is a perspective view of the suction tube 14 and shows the inlet 20 that is oriented approximately downward with respect to a plane defined by the top edge of the pan 12 of FIG. 1. Inlet 20 extends into the reservoir 18 of the pan 12 and reaches close to the bottom of the reservoir so as to be able to draw in any oil into the inlet that has collected in the reservoir 18. For example, a portion 23 of the suction tube can be provided over the higher parts of the oil pan 12, while a portion 22 of the suction tube 14 having the inlet 20 can be bent and provided at a lower elevation so that the inlet 20 is closer to the bottom of the reservoir. In some embodiments, a strainer gauze or other type of strainer (shown in FIG. 3) can be placed across the opening to the inlet 20 (or further inside the inlet 20 or suction tube 14) to filter out large particulates that may be suspended in collected oil of the reservoir 18 and pan 12.

The suction tube 14 also includes two outlets 24 and 26. These outlets are located at opposite ends of the suction tube 14, where the inlet 20 is provided between the outlets on the tube section 22 of the tube 14. As shown in FIG. 1, outlet 24 is oriented with, and/or connected to, the opening 30 in the rim 19 and located at one end of the oil pan 12, while outlet 26 is oriented with and/or connected to the opening 32 in the rim 19 at the other end of the oil pan. In some embodiments, a tube or connector from a component such as an oil pump can be welded or otherwise connected to an outlet 24 or 26 to allow a closed path from inlet 20 to that component.

As described in greater detail below with respect to FIG. 3, only one of the openings 30 or 32 and corresponding one of the outlets 24 or 26 is unblocked after the oil pan assembly 10 is installed. The unblocked opening 30 or 32 is connected to other components of the vehicle which receive the oil recirculated from the oil pan 12. Typically, an oil pump is one of the components connected, which provides the pressure to draw the oil from the reservoir and through the suction tube 14.

In some embodiments, the suction tube 14 can be made integral to the pan assembly 10, such that it and the pan 12 are considered a single part. For example, the tube 14 can be welded, glued, or otherwise attached to the pan 12. For example, in one embodiment, the suction tube 14 and oil pan 12 are made of plastic and welded together using a friction weld that melts the parts together.

The operation of oil circulation using the oil pan assembly 10 is as follows. Oil collected in the reservoir 18 of oil pan 12 is drawn into the inlet 20 of the suction tube 14 based on suction pressure provided by an oil pump or equivalent component coupled to one of the outlets of the suction tube 14. The oil is routed through the suction tube to the one of the outlets 24 or 26 of the tube that is unblocked; the other opening 24 or 26 is blocked and so no oil flows to that outlet and no other fluid ingresses. The oil flows through the unblocked outlet and through the associated opening 30 or 32 to the oil pump and/or other components of the engine or vehicle.

FIG. 3 is a perspective exploded view of the oil pan assembly 10 of FIG. 1. Rim 19 can be provided as a separate frame in some embodiments, as shown in FIG. 3, which is inserted in a corresponding slot 36 in the upper surface 38 of the oil pan 12 over the outlets 24 and 26 of the suction tube 14. The ends of the outlets 24 and 26 can include slots 40 as well, to hold the opening 30 and 32 portions of the rim 19 (shown in FIG. 1).

A strainer gauze 42 is shown below the inlet 20 of the suction tube 14 in exploded fashion. The gauze 42 fits on the end of the inlet 20 and the inlet 20 is positioned within the reservoir 18 of the pan 12.

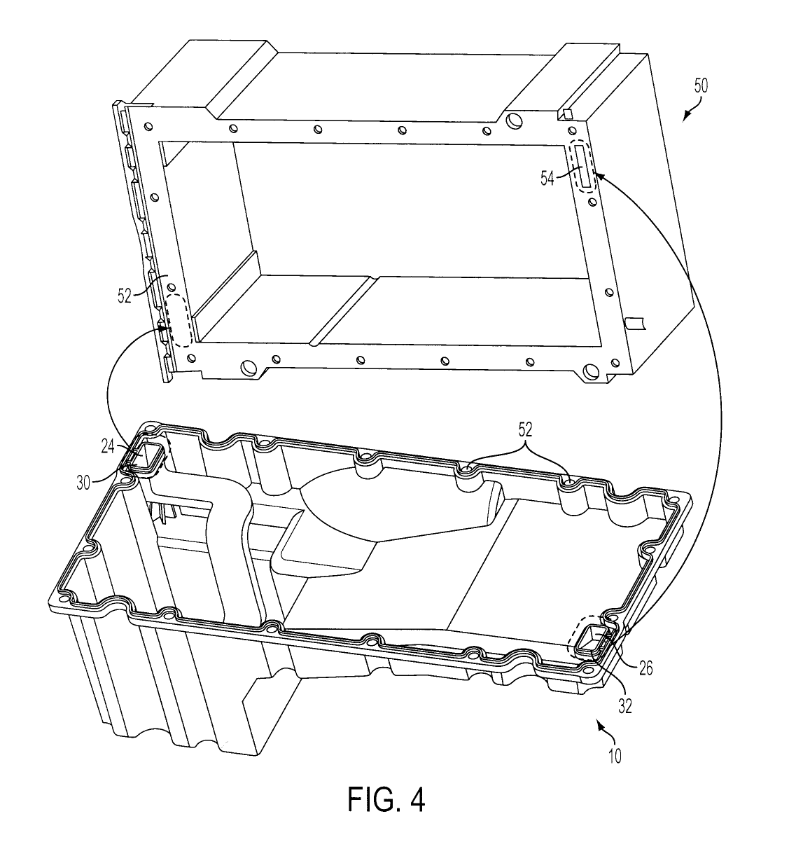

FIG. 4 is a perspective view of one example embodiment using the present invention, in which a portion 50 of an internal combustion engine is located above the oil pan assembly 10 in a vehicle. The oil pan attaches at the rim 19 to surfaces of the portion 50. In one embodiment, screws or other fasteners can be used to attach the oil pan assembly 10 to the surface the engine portion 50 via the screw holes 52 in the pan 12.

The oil pan 12 and its rim 19 are configured such that one of the openings 30 or 32 and associated outlets 24 or 26 is sealed off and blocked by one or more surfaces of the engine portion 50 after the oil pan assembly 10 is installed in a vehicle, while the other opening 32 or 30 and associated outlet 24 or 26 remains unblocked after installation. For example, the blocked opening will be sealed off and blocked by the same surface 52 to which the rim 19 is sealed to, or a different surface at the same level as the surface to which the rim 19 is sealed. Thus, in the example of FIG. 4, the opening 30 has been placed against the surface of the engine portion 50 such that opening 30 and outlet 26 are sealed off. The opening 30 can be sealed against the flywheel housing of the engine, as shown in FIG. 4, for example. In some embodiments, appropriate material can be included at the top edges of the openings 30 and 32 to help create a seal against the surface, such as rubber or other compressible material.

In contrast, the opening 32 extends to the opposite end of the engine portion 50 where an oil pump inlet (or other type of inlet) 54 is located to be connected to the opening 32 which allows oil to be drawn from the suction tube 14 and through the opening 32 to the other components that are connected to the inlet 54.

The openings 30 and 32 are positioned on the rim 19 to be correlated with two different vehicle configurations being produced. This allows the oil pan assembly 10 to be reversible and accommodate the two different vehicle configurations. In one example, a front sump vehicle configuration that needs a front sump oil pan has an engine surface that seals off the opening 30 and allows the opening 32 to be unblocked. A rear sump vehicle configuration that needs a rear sump oil pan has an engine surface that seals off the opening 32 and allows the opening 30 to be unblocked. In this fashion, a single oil pan assembly 10 can accommodate two different vehicle configurations, without having to make different parts (oil pan or suction tube) for each configuration. Furthermore, only a single strainer gauze at the single inlet 20 to the tube 14 is needed for the multiple configurations.

The openings 30 and 32 are symmetrically positioned on opposite sides of the pan 12, at the same distance from opposite (diagonal) corners of the pan, so that the pan can be reversed in different engine configurations and still provide the unblocked opening 30 or 32 in the same location relative to the engine. Space restrictions in the vehicle or other apparatus would typically prevent installation of the pan in the wrong orientation, but the simple procedure of reorienting that pan will resolve the issue and no damage due to oil starvation will have occurred.

Other configurations and components can be provided in other embodiments. For example, the openings and outlets of the oil pan assembly 10 can be provided in different locations to accommodate different configurations in vehicles. In some embodiments, the surface(s) to which the oil pan assembly is installed can be part of other, non-engine components in a vehicle or other apparatus.

In some embodiments, additional (i.e. greater than two) outlets (and associated openings) can be provided in the oil pan assembly 10 to accommodate more than two different vehicle oil pan configurations. For example, additional tube sections similar to sections 22 and 23 can be extended from the inlet extension 20 toward outlets and openings at additional positions at the edge(s) of the oil pan 12. Only one of such multiple outlets remains unblocked after installation of the oil pan assembly in the vehicle or other machine; the other outlets are blocked by surface(s) of the engine 50 or blocked by another component of the vehicle or apparatus.

The reversible pan assembly 10 of the present invention advantageously has multiple different suction tube outlets in a single reversible oil pan, and thus can be fitted for multiple configurations, such as a front sump and a rear sump vehicle configuration, without the need for a different oil pan or suction tube for each configuration. This reduces the inventory parts needed to accommodate different vehicle configurations, and also reduces the chance for errors during assembly and reduces the opportunities for scrap on the production line.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An oil pan assembly comprising:
an oil pan; and
a suction tube connected to the oil pan, the suction tube including:
an inlet to draw oil from the oil pan, and
a plurality of outlets, each outlet configured to output oil that has been moved through the suction tube from the inlet.

2. The oil pan assembly of claim 1 wherein the inlet is positioned on the suction tube between the plurality of outlets.

3. The oil pan assembly of claim 1 wherein the outlets are configured such that only one of the outlets is unblocked after installation of the oil plan assembly in an apparatus.

4. The oil pan assembly of claim 1 wherein the oil pan includes a rim, the rim including a plurality of openings, each opening associated with and coupled to one of the outlets of the suction tube.

5. The oil pan assembly of claim 4 wherein the openings in the rim of the oil pan are oriented to be parallel to the top of the rim of the oil pan, such that each opening is blocked in response to the edges of that opening being placed against a flat surface.

6. The oil pan assembly of claim 1 wherein the oil pan includes a reservoir having a greater depth than other portions of the oil pan, and wherein the inlet of the suction tube is in a portion of the suction tube that is shaped to fit into the reservoir.

7. The oil pan assembly of claim 6 wherein only the inlet includes a strainer to filter out particles in the oil drawn into the suction tube.

8. The oil pan assembly of claim 1 wherein the openings are symmetrically positioned on the rim of the oil pan near opposite corners of the oil pan.

9. An oil pan system for a vehicle, the oil pan system comprising:
an oil pan assembly comprising an oil pan and a suction tube connected to the oil pan, the suction tube including:
an inlet to draw oil from the oil pan, and
a plurality of outlets, each outlet configured to output oil that has been moved through the suction tube from the inlet;
a surface for use in a vehicle, the surface configured such that the oil pan assembly is attached to the surface, and wherein only one of the outlets of the suction tube is unblocked after attachment of the oil plan assembly.

10. The oil pan system of claim 9 wherein the inlet is positioned on the suction tube between the plurality of outlets.

11. The oil pan system of claim 9 wherein the oil pan includes a rim, the rim including a plurality of openings, each opening associated with and coupled to one of the outlets of the suction tube.

12. The oil pan system of claim 11 wherein the openings in the rim of the oil pan are oriented to be parallel to the top of the rim of the oil pan, such that the openings are blocked after the edges of the opening are placed against a flat surface.

13. The oil pan system of claim 9 wherein the surface is included in one of multiple vehicle configurations, wherein in a first of the vehicle configurations, one of the openings is blocked after the oil pan assembly is attached, and wherein in a second of the vehicle configurations, a different one of the openings is blocked after the oil pan assembly is attached.

14. The oil pan system of claim 9 wherein the first of the vehicle configurations is a front sump oil pan configuration, and the second of the vehicle configurations is a rear sump oil pan configuration.

15. The oil pan assembly of claim 9 wherein the oil pan includes a reservoir having a greater depth than other portions of the oil pan, and wherein the inlet of the suction tube is in a portion of the suction tube that is shaped to fit into the reservoir.

16. The oil pan assembly of claim 15 wherein only the inlet includes a strainer to filter out particles in the oil drawn into the suction tube.

17. The oil pan assembly of claim 9 wherein the unblocked one of the outlets is coupled to an oil pump that draws the oil through the suction tube.

18. The oil pan assembly of claim 9 wherein the openings are symmetrically positioned on the rim of the oil pan near opposite corners of the oil pan.

19. A method for providing an oil pan assembly in vehicle, the method comprising:
providing an oil pan assembly comprising an oil pan and a suction tube connected to the oil pan, the suction tube including:
an inlet to draw oil from the oil pan, and
a plurality of outlets, each outlet configured to output oil that has been moved through the suction tube from the inlet; and
attaching the oil pan assembly to a surface for use in a vehicle, wherein only one of the outlets of the suction tube is unblocked after the attachment of the oil plan assembly.

20. The method of claim 19 wherein the oil pan includes a rim, the rim including a plurality of openings, each opening associated with and coupled to one of the outlets of the suction tube, wherein each opening in the rim of the oil pan is oriented to be parallel to the top of the rim of the oil pan, such that the opening is blocked in response to the edges of the opening being placed against the surface.

21. The method of claim 19 wherein the surface is included in one of multiple vehicle configurations, wherein in a first of the vehicle configurations, one of the openings is blocked after the oil pan assembly is attached, and wherein in a second of the vehicle configurations, the other of the openings is blocked after the oil pan assembly is attached.

22. The oil pan assembly of claim 19 wherein the oil pan includes a reservoir having a greater depth than other portions of the oil pan, and wherein the inlet of the suction tube is positioned between the outlets and is in a portion of the suction tube that is shaped to fit into the reservoir.

23. The oil pan assembly of claim 19 further comprising coupling the unblocked one of the outlets to an oil pump that is operative to draw oil through the suction tube and out of the unblocked outlet.
